(19) United States
(12) Patent Application Publication
(10) Pub. No.: US 2019/0385281 A1
(43) Pub. Date: Dec. 19, 2019

(54) SYSTEM AND METHOD FOR MONITORING A SAMPLE WITH AT LEAST TWO WAVELENGTHS

(71) Applicant: CONTINUSE BIOMETRICS LTD., Tel Aviv (IL)

(72) Inventors: Zeev ZALEVSKY, Rosh HaAyin (IL); Javier GARCIA, Valencia (ES)

(21) Appl. No.: 16/484,933

(22) PCT Filed: Feb. 14, 2018
(86) PCT No.: PCT/IL2018/050170

§ 371 Date: Aug. 9, 2019

Related U.S. Application Data
(60) Provisional application No. 62/458,710, filed on Feb. 14, 2017.

(51) Int. Cl. G06T 5/00; G06T 5/50; G06T 17/00

(52) U.S. Cl. CPC G06T 5/002; G06T 2207/10152; G06T 17/00; G06T 5/50

(57) ABSTRACT

A system and technique for monitoring of one or more parameters of a sample are presented. The system comprising: an illumination unit configured for providing coherent illumination of at least two wavelength ranges and for directing said coherent illumination onto an inspection region, and a collection unit configured for collecting light returning from the inspection region and generate one or more image data pieces associated with speckle pattern generated at an intermediate plane between said inspection region and said collection unit. The use of illumination having at least two different wavelength ranges provides generation of speckles associated with mutual- interference of light of the different wavelength ranges, enabling higher efficiency and stability with respect to movement of the inspection region.

### TECHNOLOGICAL FIELD

The present invention relates generally to a system and method for monitoring parameters of a sample and particularly related to technique for reducing noise resulting from sample movement.

### BACKGROUND

Various techniques enable none-invasive detection and monitoring parameters of samples including parameters of biological tissues. Several such techniques include so-called speckle based monitoring in which coherent illumination is directed onto a region to be inspected, the coherent illumination returning from the illuminated region undergoes self-interference and generates speckle pattern, which can be collected by a defocused imaging unit (camera). Variations in the so generated speckle patterns are indicative of movement of change in orientation of the inspected region, and can thus provide data about various parameters of the sample.

U.S. Pat. No. 8,638,991 presents a method for imaging an object. The method comprises imaging a coherent speckle pattern propagating from an object, using an imaging system being focused on a plane displaced from the object.

US 2013/0144137 and US 2014/0148658 present a system and method for use in monitoring one or more conditions of a subject's body. The system includes a control unit which includes an input port for receiving image data, a memory utility, and a processor utility. The image data is indicative of data measured by a pixel detector array and is in the form of a sequence of speckle patterns generated by a portion of the subject's body in response to illumination thereof by coherent light according to a certain sampling time pattern. The memory utility stores one or more predetermined models, the model comprising data indicative of a relation between one or more measurable parameters and one or more conditions of the subject's body. The processor utility is configured and operable for processing the image data to determine one or more corresponding body conditions; and generating output data indicative of the corresponding body conditions.

### GENERAL DESCRIPTION

As indicated above, speckle detection based techniques for monitoring parameters of a sample provides efficient, accurate and none-invasive techniques enabling detection and monitoring of various parameters. Generally, these techniques provide detection of vibrations and movement of the inspection region, which may be indicative of one or more parameters of interest. However, low frequency movements, e.g. hand movement of a patient while being inspected, typically cause signal additional introducing noise in the detected signal and may thus reduce the quality of the collected data.

The technique of the present invention provides a modification of the speckle-based monitoring, utilizing illumination of the inspection region by light of two or more wavelengths. The different wavelengths are selected to be relatively close, e.g. different of 2-20 nm, to enable a level of mutual interference between different light components. The technique further utilizes defocused collection of light returned from the inspection region by a collection unit, providing a sequence of image data pieces associated with speckle patterns generated from interference of light components returning/scattering from the inspection region. According to the present technique, selection of the two or more wavelengths and arrangement of the collection unit are configured for collecting data about speckle pattern formed by mutual interference of light components of different wavelengths.

As indicated, illumination of the inspected region is provided by light of two or more wavelength. This may be done either by two or more light sources or using a light source having sufficiently broad band and a wavelength selective filter arrangement (e.g. prism). Preferably, light components corresponding to the different wavelength are directed to impinge on the inspected region with small angular variation 0 between them. This configuration results in enveloped speckles generated due to a combination of interference between light components of the same wavelength and light components of the different wavelengths. collection of light returning from the inspection region, using imaging system configured for imaging an intermediate plane (located between the inspection region and the imaging unit), will provide speckle patterns including one or more patterns of smaller speckles associated with interference of light components of each wavelength with themselves, enveloped by larger speckles associated with interference of light components of the different wavelengths.

Similarly to the previously described speckle-based monitoring, a sequence of image data pieces, each associated with a speckle pattern, is collected at a selected frame rate. The sequence of images is than processed for determining correlation between speckle patterns in consecutive images, which is indicative of movements and/or vibrations of the inspection region. The use of two or more wavelength of illumination provides, according to the present technique, generation of speckles associated with multi-wavelength interference. Such speckles are characterized as having relatively larger dimensions and longer lifetime longer period, thus providing effective averaging of some of the movement or vibrations at the inspected region. The averaging provided by the larger speckles enables filtering out data associated with slow movements of the inspection while maintains accurate detection of rapid, nano-vibration, providing variations in both speckles formed by each of the wavelength (herein referred to as smaller speckles) and speckles formed by multi-wavelength interference (referred to as larger speckles). The collected speckle patterns are generally formed by overlaying arrangement of the smaller and larger speckles.

This monitoring technique may also be used to provide tomographic data of the inspection region. This may be accomplished by monitoring the region from a plurality of different directions, while generally maintaining a respective angular relation between illumination and light collection, to thereby provide three-dimensional data indicative of selected parameters of the sample. Generally, for each measurement direction, a sequence of a predetermined number of frames is collected processed. After collecting and processing data from selected monitoring directions, the integral scattering data may be further processed, e.g. using Radon transform, to provide three-dimensional data about the sample. To this end the present technique may utilize an arrangement of illumination and collection units mounted on a moveable or rotatable arm enabling to selectively vary direction of inspection. As indicated above, the illumination unit provides optical illumination of two or more wavelengths with selected angular relation between them the collection unit is configured for collecting selected sequence of respective image data pieces for each direction of illumination.

Thus, according to a broad aspect thereof, the present invention provides a system for monitoring of one or more parameters of a sample, the system comprising an illumination unit configured for providing coherent illumination of at least two wavelength ranges and for directing said coherent illumination onto an inspection region, and a collection unit configured for collecting light returning from the inspection region and generate one or more image data pieces associated with speckle pattern generated at an intermediate plane between said inspection region and said collection unit. The at least two wavelength ranges are at least partially different between them. More specifically, central wavelengths of the different wavelength ranges are different, while there may be some overlap in accordance with width of the at least two wavelength ranges.

According to some embodiments, for a given angle of illumination incident of the inspection region, the at least two wavelengths may be selected to form speckles having general size associated with two or more pixels of image collection.

Generally, according to some embodiments, the system may further comprise a control unit configured and operable for managing operation of said illumination and collection units, and for receiving and processing one or more sequences of image data pieces collected by said collection unit for determining one or more parameters of a sample being inspected; said processing comprises determining correlation function between speckle patterns of consecutive image data pieces. The processing may comprise determining correlation between patterns of speckles generated by interference of light components of said two or more wavelengths.

According to some embodiments, the system may further comprise a rotating frame configured for rotating around a location corresponding to said inspection region within a selected number of inspection angles, and a control unit configured for operating the illumination and collection unit for acquiring a selected number of image data pieces from a selected number of a plurality of inspection angles thereby providing image data indicative of a three-dimensional model of the inspection region.

Thus, according to a broad aspect of the present invention, the invention provides a system for monitoring of one or more parameters of a sample, the system comprising:

an illumination unit configured for providing coherent illumination of at least two wavelength ranges and for directing said coherent illumination onto an inspection region, and

a collection unit configured for collecting light returning from the inspection region and generate one or more image data pieces associated with speckle pattern generated at an intermediate plane between said inspection region and said collection unit.

According to some embodiments, the at least two wavelength ranges are at least partially different between them. Generally, the different wavelength ranges may comprise central wavelengths differing between them by 5-50 nm, in some configurations the central wavelengths differ by 5-15 nm.

According to some embodiments, for a given angle of illumination incident on the inspection region, said at least two wavelengths may be selected to form speckles having general size associated with two or more pixels of image collection.

According to some embodiments, the system may further comprise a control unit configured and operable for managing operation of said illumination and collection units, and for receiving and processing one or more sequences of image data pieces collected by said collection unit for determining one or more parameters of a sample being inspected; said processing comprises determining at least one correlation function between speckle patterns of consecutive image data pieces.

Processing of the one or more sequences of image data may comprise determining correlation between patterns of speckles generated by interference of light components of said two or more wavelengths.

According to some embodiments of the invention, the system may further comprise a rotating frame, or rotating arm, configured for rotating around a location corresponding to said inspection region within a selected number of inspection angles, and a control unit configured for operating the illumination and collection unit for acquiring a selected number of image data pieces from a selected number of a plurality of inspection angles thereby providing image data indicative of a three-dimensional model of the inspection region.

According to yet some embodiments of the invention, the illumination unit may be configured for providing at least two output light beams, corresponding with said at least two wavelength ranges, propagating along at least two different optical axes intersecting at said inspection region, thereby forming at least partially overlapping illumination spots on the inspection region. The angle between the at least two different optical axes may be between 1 and 30 degrees, or between 1 and 10 degrees.

According to yet some embodiments of the invention, the collection unit may be configured with optical magnification factor providing resolved imaging of speckle patterns associated with mutual interference of light components of said at least two wavelength ranges.

The optical magnification factor of the collected unit may generally be selected for filtering out speckle patterns formed by self-interference of any one of said at least two wavelength ranges.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a system for monitoring of an object according to some embodiments of the invention;

FIG. 2 shows cross section of a portion of collected speckle pattern including self-interferences and mutual-interference relates speckles; and

FIG. 3 exemplifies system configuration for monitoring of a sample from a plurality of angular directions according to some embodiments of the invention.

### DETAILED DESCRIPTION OF EMBODIMENTS

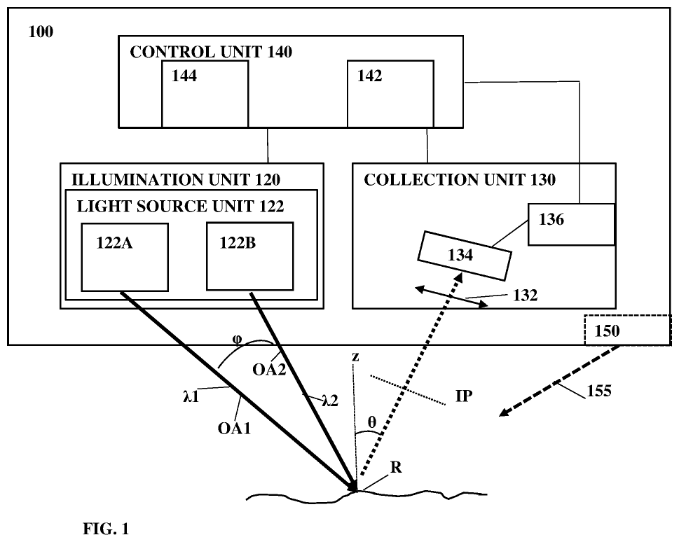

Reference is made to FIG. 1, illustrating a system 100 for monitoring of a sample. The system 100 includes an illumination unit 120 configured to provide illumination of selected one or more regions of the sample, exemplified herein as region R, with coherent illumination of at least two wavelength ranges (λ1 and λ2 in this example), and a collection unit 130 configured for collecting light returning from the region R and generate image data indicative of one or more speckle patterns formed by interference of light components scattering from the surface R. Additionally the system 100 may typically include, or be connectable to, a control unit 140 configured for operating the illumination 120 and collection 130 units with selected or predetermined parameters and for receiving collected image data pieces from the collection unit 130 and store or transmit to a dedicated controller for further processing. Generally, the control unit 140 may be configured for selectively adjusting sampling parameter associated with at least one, or both, of the illumination unit 120 and collection unit 130. For example, the control unit may selectively modify illumination parameters such as illumination intensity, wavelengths, operation in continuous wave (CW) or pulsating modes and repetition rate of pulsating illumination. Additionally or alternatively, the control unit may be configured to selectively modify collection parameters such as frame rate, exposure/acquisition time, focusing distance, numerical aperture and other operational parameters. In some embodiments, the control unit 140 may also include a processing utility 142, typically including one or more processors and associated with corresponding storage utility 144, configured for processing one or more sequences of image data pieces for determining data about one or more parameters of the sample. System 100 may also include a stimulation unit 150 configured for selectively applying stimulation field directed at the inspection region R.

The illumination unit 120 as exemplified in FIG. 1 generally includes a light source unit 122, e.g. laser system, configured for providing coherent illumination with at least two wavelength ranges. This is exemplified in FIG. 1 by first and second laser units 122A and 122B. It should however be noted that the light source unit 122 may include a single broadband laser and suitable chromatic splitting unit such as dichroic mirror and/or prism for separating light of different wavelength ranges to provide illumination of two or more wavelengths.

Additionally, the illumination unit 120 may also include one or more optical elements, not specifically shown here, configured for directing the coherent illumination of the light source unit 122 toward the inspection region R. The one or more optical elements may generally include one or more lenses, attenuators, apertures, etc. and are typically configured for enabling selection of spot size and intensity at the inspection region R. The light source unit 122 may generally utilize the associated optical elements for directing the illumination of two or more wavelengths to propagate along corresponding two or more optical axes intersecting at the inspection region R. More specifically, light components of different wavelength ranges are directed to impinge on a common illumination spot, or at least to provide overlapping spots, on the inspection region R while having certain angular difference between directions of propagation of the different light components. Thus, light components of different wavelengths propagate toward the inspection region R while forming an angle φ between the corresponding axes. Generally, the angular difference φ between light components of different wavelength ranges may be in the rage of 0≤|φ|≤10°. The two or more illumination axes propagate toward the inspection region R to illuminate substantially the same region of the sample.

The collection unit 130 is configured for collecting light returning/scattering from the inspection region R and for generating a sequence of image data pieces at a predetermined frame rate. The collection unit 130 may be configured in the form of a camera unit, generally including a detector array 134 and an imaging lens arrangement 132. Additionally, the collection unit may include, or be connected to, a collection controller 136 including an actuator for selection of the frame rate and for reading the collected image data from the detector array 134.

The imaging lens arrangement 132, exemplified here by imaging lens but may include additional lenses and/or other optical elements such as apertures, is configured for collecting light and generating corresponding image on the detector array 134. The arrangement of the detector array 134 and the optical lens arrangement 132 is configured to provide defocused imaging with respect to the inspection region R. More specifically, the image formed on the detector array generally corresponds to an intermediate object plane IP, which may be located between the inspection region and the collection unit 130, or distant with respect to the inspection region R. Thus, the so-generated images are indicative of speckle patterns generated from interference of light components returning/scattering from the inspection region.

Generally, the different wavelengths λ1 and λ2 (and additional wavelengths if used) are selected to be relatively close between them. More specifically, the wavelengths λ1 and λ2 are typically selected such that a difference between different wavelengths is much smaller than the average wavelength. Additionally, the different wavelengths λ1 and λ2 may generally be selected to provide speckles of dimension suitable for collection and imaging on the detector array 134, e.g. difference between wavelengths providing that speckle size is of the order of 3-500 pixels as collected on the detector array 134 for given arrangement of the optical lens arrangement 132 and the detector array 134. Illumination of the inspection region with coherent light of two or more different wavelengths may, if wavelengths are sufficiently close, generate mutual-interferences (heterodyne) speckles associated with a difference between the different wavelengths. Such mutual interference speckle patterns are superimposed on the self-interference speckle patterns associated with each of the different wavelength.

The mutual-interference speckle patterns include speckles of relatively large dimension, having characteristic dimension corresponding to inverse of the difference between the wavelengths. Thus, the so-generated speckle patterns include speckles of different sizes such as smaller (self-interference) speckles enveloped within larger (heterodyne or mutual interference) speckles. Generally, denoting an intensity map captured by the detector 134 of the collection unit 130 camera by I(x,y) where E_{λ1} and E_{λ2} are the optical fields of the self-interference patterns for wavelength λ1 and λ2, characteristics of the collected speckle patterns may be approximately described by the following expression:

$$I ( x , y ) = {\vert {E}_{{λ}_{1}} ( x , y ) exp ( \frac{2 π}{{λ}_{1}} ) x sin θ + {E}_{{λ}_{2}} ( x , y ) exp ( \frac{2 π}{{λ}_{2}} ) x sin θ \vert}^{2} = {\vert {E}_{{λ}_{1}} ( x , y ) \vert}^{2} + {\vert {E}_{{λ}_{2}} ( x , y ) \vert}^{2} + 2 \vert {E}_{{λ}_{1}} ( x , y ) \vert \cdot \vert {E}_{{λ}_{2}} ( x , y ) \vert \cdot cos ( 2 π x sin θ ( \frac{1}{{λ}_{1}} - \frac{1}{{λ}_{2}} ) ) \qquad ( Equation 1 )$$

where the x-y plane corresponding to collection surface of detector array 134, B is angle of direction of propagation from the inspection region R with respect to the z axis.

Generally, as the different wavelengths λ1 and λ2 are selected to be very close to each other, i.e. the difference between the two wavelengths is small with respect to the nominal wavelength, the corresponding difference between the field distributions E_{λ1}(x,y) and E_{λ2}(x,y) can be approximately negligible providing a simplified description of the:

$$I ( x , y ) = 2 {\vert {E}_{λ} ( x , y ) \vert}^{2} [ 1 + cos ( 2 π x sin θ ( \frac{1}{{λ}_{1}} - \frac{1}{{λ}_{2}} ) ) ] = 2 {\vert {E}_{λ} ( x , y ) \vert}^{2} [ 1 + cos ( 2 π x sin θ ( \frac{Δ λ}{{λ}_{1} {λ}_{2}} ) ) ] . \qquad ( Equation 2 )$$

Equation 2 exemplifies self-interference speckle pattern E_{λ} formed by self-interference of light components of wavelength λ1 and λ2 superimposed with the heterodyne speckles associated with mutual interferences of light components of the different wavelengths. The mutual interference speckles have general dimension (spatial period) of

$$P = \frac{{λ}_{1} {λ}_{2}}{Δ λsin θ} .$$

To take advantage of the larger heterodyne speckles in noise reduction, the collection unit is preferably configured such that the period P of the heterodyne speckles is within a range of several pixels of the detector array 134. Alternatively, or additionally, the illumination unit 120 is configured to provide coherent illumination of two or more selected wavelengths having difference between, such that together with respective alignment of the illumination 120 and collection 130 units, the period of the heterodyne speckles provides speckle dimensions corresponds to several (e.g. 5 to 500) pixels in accordance with physical size of the collection unit 130. This results in generating speckle patters that are relatively stable with respect to constant (low frequency) movement of the inspection region R.

Further, the collection unit 130 and the detector array thereof 134 may be configured such that typical size of the smaller (self-interference related) speckles is of the order of a single detector element/pixel or less. This provides effective optical filtering of the small (self-interference) speckles and enables detection of the heterodyne speckles and differentiating between speckle formed by mutual-interference or self-interference.

The collection unit 130 is configured and operable for generating a sequence of image data pieces at a selected frame rate. Each frame includes image data piece having data on one or more speckle patterns generated by interference of light components returning from the inspection region R. The sequence of image data pieces (images) may be transferred to the control unit 140 for processing, storing and/or transmitted to be processed by a remote, separate processor utility, to determine selected parameters of the subject. Generally, the processing of the image data pieces utilizes determining one or more correlation functions between consecutive image data piece. A set of such correlation functions along time provides time correlation function indicating variation in orientation, curvature and/or location of the inspection region and may be translated to represent data on vibrations or movements of the inspection region R.

In some embodiments of the invention, the system 100 may also include a stimulation unit 150 configured to provide selected external stimulation 155 on, or in vicinity of, the inspection region R. In this connection it should be noted that the present technique and speckle-based monitoring in general, may utilize external stimulation field for monitoring certain properties of various samples. The external stimulation field may be magnetic field, used for monitoring parameters such as glucose or alcohol concentration in patient's blood, or ultra-sonic stimulation field that is typically used for determining structural parameters of a tissue or sample. In such configurations, the stimulation unit 150 is used, configured for applying external stimulation directed to the inspection region R. The control unit 140 is configured for processing the collected image data pieces and correlations between the for determining one or more parameters that are associated with sample response to the external field. For example, external stimulation field in the form of ultrasound waves may generate forced vibrations on the inspection region, resulting in elastic response that can be detected and measured by the present technique. Additionally or alternatively, magnetic field may interact with specific materials, e.g. glucose resulting in light-matter interactions such as Faraday Rotation of light polarization, enabling detection of the relevant materials. Additional external field may be used, including, but not limited to, acoustic fields, infra-sound, etc.

Processing of the collected sequence of image data pieces is based on determining correlation function between speckle patterns in consecutive images. The correlation function between different speckle patterns are indicative of location and/or orientation of the surface of the inspected region R, providing data indicative of movement/vibrations of the inspection region. Such data may be associated with various parameters including elastic data about a sample as well as medical parameters such as: heart rate, breathing rate, blood pulse pressure, blood hematology (e.g. glucose level, alcohol level and concentration of various chemicals in the blood stream).

The technique of the invention enables monitoring of the selected parameters while averaging out noise associated with slow and stable movement (with respect to the acquisition frame rate). This is provided by creation of relatively large speckles formed by mutual interference of light components of two or more wavelength ranges. Detection of the speckles formed by mutual interference is provided in accordance with magnification of the imaging lens arrangement 132 with respect to the detector array 134 for collecting image data such that speckles of characteristic size

$$P = \frac{{λ}_{1} {λ}_{2}}{Δ λsin θ} \frac{L}{\sqrt{A}}$$

are collected on region of 3-500 pixels, while speckle of general dimensions

$$s = λ \frac{L}{\sqrt{A}}$$

(where L is the distance between the inspection region and the collection unit, and A is the area of the inspection region) are smaller and correspond to region of one pixel or less on the detector 134. This configuration provides effective filtering of low frequency vibrations and acts as motion compensation with respect to movements of the inspection region, thus enabling, e.g., monitoring of a patient while reducing noise associated with general movement of the patient, such as hands movement.

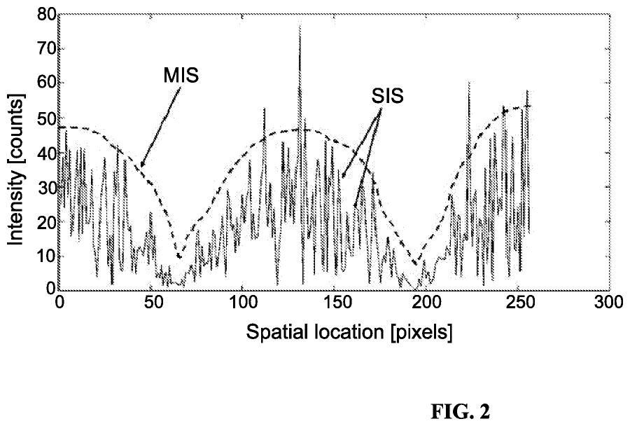

In this connection, FIG. 2 shows a cross section of collected speckle pattern including speckles formed by self-interference of light of the same wavelength SIS and speckle envelope formed by mutual-interference of light of two wavelengths used for illuminating the inspection region MIS. As shown, the mutual-interference (Heterodyne) speckles MIS are larger with respect to the self-interference speckles SIS, and are superimposed on the general speckle pattern. Averaging of the smaller speckles SIS using detector array having geometric resolution that is larger than the typical speckle SIS size will provide filtering out of these speckles and enable detection of the heterodyne speckle MIS providing higher stability with respect to low frequency/low speed movements of the inspection region.

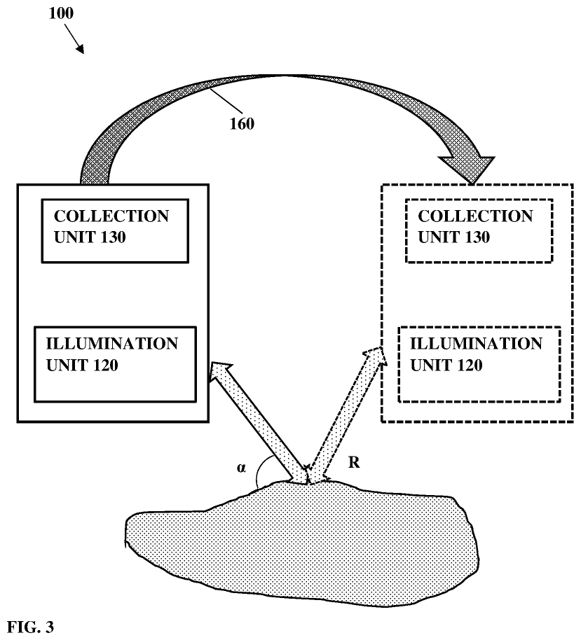

Additionally, as indicated above, the sample may be monitored from a plurality of different direction, e.g. by rotating the monitoring system around the inspection region R, to provide three-dimensional monitoring of the selected parameters. This technique is exemplified in FIG. 3 showing partial illustration of system 100, where the collection unit 130 and illumination unit 120 are mounted on moveable or rotatable arm exemplified by rotation path 160. In this example, the system 100 is configured for collecting a sequence of image data pieces associated with speckle patterns formed by illumination of the inspection region R from one direction. After collection of a sequence, the moving arm shifts the monitoring direction and the system continues collecting a sequence of image data pieces from another direction. By monitoring the sample, or inspection region thereof, from a plurality of different directions, the collected data may be used for generating tomographic model of one or more monitored properties. Such tomographic monitoring may be used for mapping variations of selected parameters within a volume of the sample and construct a three-dimensional model based on one or more selected parameters. To this end a region (volume) of a sample may be monitored by the system 100 while the system 100 is configured for acquiring a sequence of selected images from certain angular direction (angle a with respect to the sample). After acquiring a selected number of images, the system may be shifted for monitoring the same region from a different direction, i.e. varying the angle α. The images collected from a plurality of directions may be processed for determining three-dimensional model of the sample using image data indicative of the heterodyne speckle patterns as captured. The three-dimensional model may be determined using various known mathematical techniques, e.g. by Radon transform, for determining three-dimensional model of the sample (inspection region). Further, the so-generated three-dimensional model may be further processed for determining correlation functions between speckle patterns and thus determining data about parameters of the sample. Usage of the temporal changes of the heterodyne speckle images enables extraction of integral (projection) “vibrations” image sensed from a given observation direction. Right after we perform an inverse Radon transform (after capturing such images from different angles) in order to perform tomographic 3D reconstruction (similarly to what is being done in CT but here it is images of integral scattering instead of images of integral absorption) of “vibrations” modes.

Thus, the technique of the invention provides for monitoring of one or more selected parameters of an object. The technique includes illuminating a selected region (inspection region) with coherent illumination including two or more wavelengths, preferably with certain angular difference between them, and collecting light returned from the region for generating a sequence of image data pieces indicative of speckle patterns generated from interference of light components of one wavelength with light components of another wavelength. Difference between the wavelengths and alignment of illumination and collection paths are selected to provide speckle pattern including speckles having general dimension associated with a plurality of pixels used for detection. This provides monitoring using speckle patterns having low response to stable and slow movement of the inspection region and thus reduces noise associated with low frequency movement of the sample.

1. A system for monitoring of one or more parameters of a sample, the system comprising:
an illumination unit configured for providing coherent illumination of at least two wavelength ranges and for directing said coherent illumination onto an inspection region, and
a collection unit configured for collecting light returning from the inspection region and generate one or more image data pieces associated with speckle pattern generated at an intermediate plane between said inspection region and said collection unit.

2. The system of claim 1, wherein said at least two wavelength ranges are at least partially different between them.

3. The system of claim 1, wherein, for a given angle of illumination incident on the inspection region, said at least two wavelengths being selected to form speckles having general size associated with two or more pixels of image collection.

4. The system of claim 1, further comprising a control unit configured and operable for managing operation of said illumination and collection units, and for receiving and processing one or more sequences of image data pieces collected by said collection unit for determining one or more parameters of a sample being inspected; said processing comprises determining at least one correlation function between speckle patterns of consecutive image data pieces.

5. The system of claim 4, wherein said processing comprises determining correlation between patterns of speckles generated by interference of light components of said two or more wavelengths.

6. The system of claim 1, further comprising a rotating frame configured for rotating around a location corresponding to said inspection region within a selected number of inspection angles, and a control unit configured for operating the illumination and collection unit for acquiring a selected number of image data pieces from a selected number of a plurality of inspection angles thereby providing image data indicative of a three-dimensional model of the inspection region.

7. The system of claim 1, wherein said illumination unit is configured for providing at least two output light beams, corresponding with said at least two wavelength ranges, propagating along at least two different optical axes intersecting at said inspection region, thereby forming at least partially overlapping illumination spots on the inspection region.

8. The system of claim 7, wherein an angle between the at least two different optical axes is between 1 and 30 degrees.

9. The system of claim 7, wherein an angle between the at least two different optical axes is between 1 and 10 degrees.

10. The system of claim 1, wherein said collection unit has optical magnification factor providing resolved imaging of speckle patterns associated with mutual interference of light components of said at least two wavelength ranges.

11. The system of claim 10, wherein said optical magnification factor of the collected unit is selected for filtering out speckle patterns formed by self-interference of any one of said at least two wavelength ranges.
